(19) United States
(12) Patent Application Publication
(10) Pub. No.: US 2008/0140765 A1
(43) Pub. Date: Jun. 12, 2008

(54) EFFICIENT AND REPRODUCIBLE VISITOR TARGETING BASED ON PROPAGATION OF COOKIE INFORMATION

(75) Inventors: Paul Kelaita, San Mateo, CA (US); Philip Aaronson, Mountain View, CA (US); Venkatesh B. Natrajan, San Jose, CA (US); Cheng-Chuan Chou, Sunnyvale, CA (US); Daniel Benjamin, Hoboken, NJ (US); Kamal Ali, Campbell, CA (US)

Correspondence Address: Yahoo! Inc.;c/o DARBY & DARBY P.C., P.O. BOX 770, Church Street Station, NEW YORK, NY, 10008-0770, US

(73) Assignee: Yahoo! Inc., Sunnyvale, CA (US)

(21) Appl. No.: 11/608,230

(22) Filed: Dec. 7, 2006

(51) Int. Cl. G06F 15/16

(52) U.S. Cl. 709/203

(57) ABSTRACT

A device, system, and method are directed towards providing content over a network. A test definition is defined to include at least one group of visitors and/or a range associated with the group. The test definition is then received. A plurality of requests for a first content is received from the same browser. Each of the plurality of requests includes a previously generated value (PGV)/cookie. For each of the plurality of requests, a fast-hash is performed on the same PGV/cookie to generate an identifier (e.g., number). It is then determined whether to provide a second content instead of the first content based on whether the identifier is in the range associated with the at least one group of visitors. The determination may also be based on a URL filter, a browser type, operating system type, a time-range, or an argument-value pair. The first or second content is then provided.

### TECHNICAL FIELD

The present invention relates generally to communications and, more particularly, but not exclusively to providing a content over a network, and more specifically providing reproducible content to a visitor based on cookie information provided by the visitor.

### BACKGROUND

The Web provides information at an increasing pace. One result of this pace is that a content provider must determine if new content will be suitable for visitors. Content providers may experiment (e.g., performing testing) to determine suitability of new content. Thus, content providers often need a way to select visitors in a reproducible way and put them into a group that could then be treated or monitored separately from other groups in a given experiment/test.

In the past, content providers may use a tool that randomizes each visitor's content upon the visitor's first visit. Using this technique, the same content may not be provided to the same visitor upon subsequent visits. This could lead to skewed experiment/test results as the number of experiments/tests grows to more than one.

Using another technique, content providers may randomly select visitors and then tag the visitors to identify the visitors upon their return. This technique is more prone to error as two different experiments/tests may randomly choose the same visitor to be in the two different experiments/tests. This result goes against accepted “design of experiment” practices that call for more controlled and isolated testing.

Moreover, these techniques may also produce significant overhead and affect performance. Therefore, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 shows components of an environment in which one or more embodiments of the invention may be practiced;

FIG. 2 shows one embodiment of a client device that may be included in a system implementing one or more embodiments of the invention;

FIG. 3 shows one embodiment of a network device that may be included in a system implementing one or more embodiments of the invention;

FIG. 4 shows one embodiment of another network device that may be included in a system implementing one or more embodiments of the invention;

FIG. 5 illustrates a logical flow diagram generally showing one embodiment of a process for providing content over a network;

FIG. 6 shows an example XML test definition file according to one embodiment of the invention; and

FIG. 7 shows an alternate logical architecture according to one embodiment of the invention.

### DETAILED DESCRIPTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “experiment” refers to a grouping of possible “test cases” or simply “tests.” The experiment may be defined by any number of criteria, including whether a request for content matches a URL pattern/filter, whether the request is from a particular location, or the like. Moreover, the experiment can be defined hierarchically, such that sub-experiments may satisfy and have the characteristics of their parent experiments.

The term “test” refers to an operation or operations performed on visitors in a particular group of visitors to a website. The operations may include, but are not limited to, providing different content, than to other visitors who are not in the particular group, providing content based on different algorithms, providing different access rights, restrictions, or the like.

The terms “web request” or “request” refers to any information accessible over any network protocol, including an Open Systems Interconnection (OSI) layer 7 network protocol. The request may be identified by a Uniform Resource Locator (URL), Uniform Resource Identifier (URI), or the like. The information may be requested via a Hyper Text Transfer Protocol (HTTP) protocol, a HTTPS (HTTP using Secured Socket Layer) protocol, a File Transfer Protocol (FTP), a web service, or the like. The HTTP protocol is described for example, in Request for Comments (RFC) 2145, RFC 2616 or RFC 2774, which are incorporated herein by reference.

The terms “web page,” “web content,” or simply “content” refer to any data directed towards a user of a computing device, including, but not limited to markup language text (e.g., HTML, XML), audio data, multimedia data, photographs, video data, still images, text, graphics, animation files, voice messages, text messages, or the like.

As used herein, the term “instance of a browser” refers to a copy of a browser of a particular type executable on a computing device.

As used herein, the term “cookie” refers to an HTTP cookie, as described for example, in RFC 2109 and/or RFC 2965, which are incorporated herein by reference. A cookie may include a particular type of cookie configured to uniquely identify a browser type, an instance of a browser, a visitor (e.g., user of the browser), an operating system, or the like. A cookie may, for example, be a B-Cookie.

Briefly stated, various embodiments are directed towards providing content over a network. A test definition is defined, wherein the test definition includes at least one group of visitors. The test definition, including at least one range associated with at least one group of visitors is received. A plurality of requests for a first content is received from the same browser. Each of the plurality of requests includes a previously generated value (PGV). The PGV may include a cookie. The cookie may identify the browser. For each of the plurality of requests, a fast-hash may be performed on the same PGV/cookie to generate an identifier (e.g., number). It is then determined whether to provide a second content instead of the first content based on whether the identifier is in the range associated with the at least one group of visitors. The determination may also be based on a URL filter, a browser type, operating system type, a time-range, or an argument-value pair. The first or second content is then provided. Thus, the same content may consistently be provided to the same visitor.

### Illustrative Operating Environment

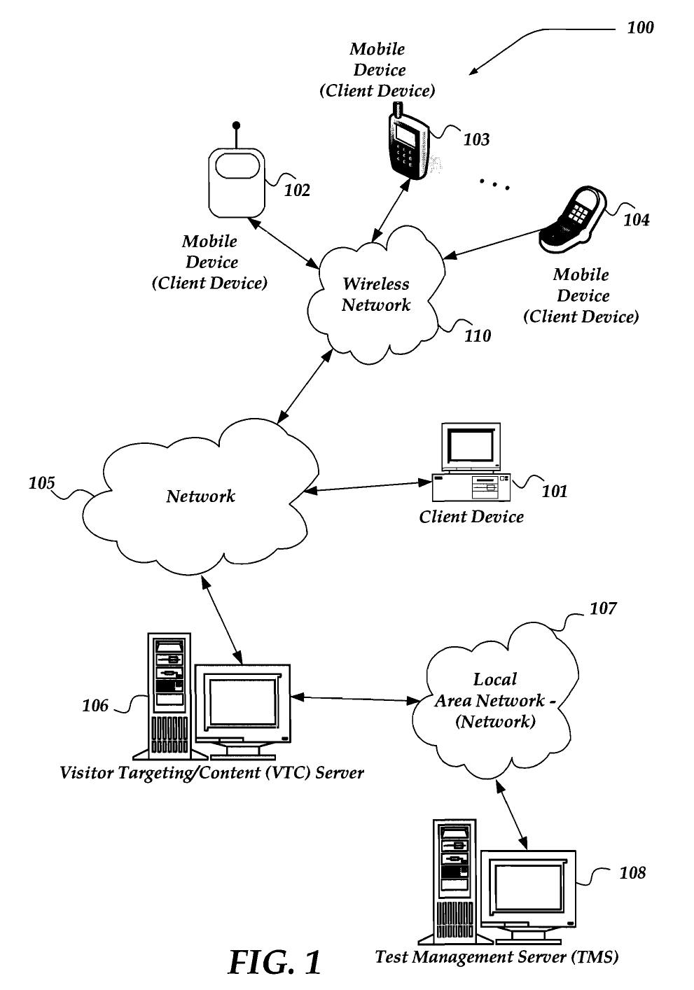

FIG. 1 shows components of an environment in which one or more embodiments of the invention may be practiced. Not all the components may be required to practice the invention, and variations in the arrangement and type of the components may be made without departing from the spirit or scope of the invention. As shown, system 100 of FIG. 1 includes local area networks (“LANs”) 107, network 105, wireless network 110, Visitor Targeting/Content (VTC) server 106, Test Manager Server (TMS) 108, mobile devices (client devices) 102-104, and client device 101.

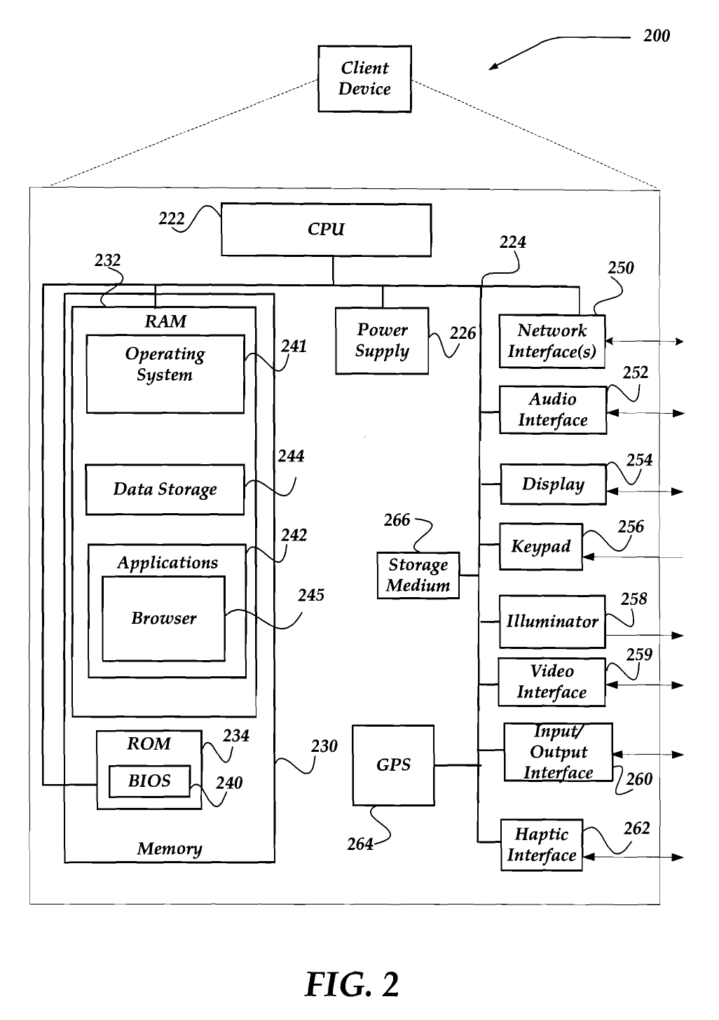

One embodiment of mobile devices 102-104 is described in more detail below in conjunction with FIG. 2. Generally, however, mobile devices 102-104 may include virtually any portable computing device capable of receiving and sending a message over a network, such as network 105, wireless network 110, or the like. Mobile devices 102-104 may also be described generally as client devices that are configured to be portable. Thus, mobile devices 102-104 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, and the like. As such, mobile devices 102-104 typically range widely in terms of capabilities and features. For example, a cell phone may have a numeric keypad and a few lines of monochrome LCD display on which only text may be displayed. In another example, a web-enabled mobile device may have a touch sensitive screen, a stylus, and several lines of color LCD display in which both text and graphics may be displayed.

A web-enabled mobile device may include a browser application that is configured to receive and to send web pages, web-based messages, and the like. The browser application may be configured to receive and display graphics, text, multimedia, and the like, employing virtually any web based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), extensible Markup Language (XML), and the like, to display and send a message. The browser application may communicate with a server, such as VTC server 106, over any network protocol, including an OSI layer 7 network protocol. For example, the browser of mobile devices 102-104 may communicate with VTC server 106 thorough network 110 and network 105, over HTTP, HTTPS, or the like.

In one embodiment, the browser application may receive, manage, maintain and/or send a cookie to a server, such as VTC server 106. In one embodiment, the cookie may be a B-Cookie. The B-Cookie may identify the browser application (e.g., an instance of a browser). The B-Cookie may be persistent and may be associated with the browser application between several executions of the browser application.

Mobile devices 102-104 also may include at least one other client application that is configured to receive content from another computing device. The client application may include a capability to provide and receive textual content, media content, and the like. The client application may further provide information that identifies itself, including a type, capability, name, and the like. In one embodiment, mobile devices 102-104 may uniquely identify themselves through any of a variety of mechanisms, including a phone number, Mobile Identification Number (MIN), an electronic serial number (ESN), or other mobile device identifier. The information may also indicate a content format that the mobile device is enabled to employ. Such information may be provided in a message, or the like, sent to VTC server 106, client device 101, or other computing devices.

Mobile devices 102-104 may also be configured to communicate a message, such as through Short Message Service (SMS), Multimedia Message Service (MMS), instant messaging (IM), internet relay chat (IRC), Mardam-Bey's IRC (mIRC), Jabber, and the like, between another computing device, such as VTC server 106, client device 101, each other, or the like. However, the present invention is not limited to these message protocols, and virtually any other message protocol may be employed. For example, the client application may enable a user to interact with the browser application, email application, VoIP applications, or the like.

Mobile devices 102-104 may further be configured to include a client application that enables a visitor to log into an account that may be managed by another computing device, such as VTC server 106. Such account, for example, may be configured to enable the visitor to receive emails, send/receive IM messages, SMS messages, access web content, access selected web pages, or the like. In one embodiment, after a visitor logs in, another cookie associated with the visitor may be sent to a server, such as VTC server 106.

In addition, mobile devices 102-104 may include another application that is configured to enable the mobile user to share and/or receive content, and to display the content. In one embodiment, each of mobile devices 102-104 may share with and/or receive the content from VTC server 106 and/or from another one of mobile devices 102-104. For example, content may be shared between the mobile devices using MMS, WAP, or the like. In one embodiment, a mobile device may receive a message indicating the content is available for viewing and/or annotating at a website, such as at a website available on VTC server 106, or the like.

Client device 101 may include virtually any computing device capable of communicating over a network to send and receive information or the like. One embodiment of client device 101 is described in more detail below in conjunction with FIG. 2. Generally however, the set of such devices may include devices that typically connect using a wired or wireless communications medium such as personal computers, multiprocessor systems, microprocessor-based or programmable consumer electronics, network PCs, or the like. In one embodiment, client device 101 may be configured to access a website, or other location, or the like. Similar to mobile devices 102-104, client device 101 may be configured to access web content from VTC server 106 through network 105. A browser application on client device 101 may also manage and/or send a cookie(s) (e.g., a B-Cookie) to VTC server 106.

Wireless network 110 is configured to couple mobile devices 102-104 and its components with network 105. Wireless network 110 may include any of a variety of wireless sub-networks that may further overlay stand-alone ad-hoc networks, and the like, to provide an infrastructure-oriented connection for mobile devices 102-104. Such sub-networks may include mesh networks, Wireless LAN (WLAN) networks, cellular networks, and the like.

Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as mobile devices 102-104 with various degrees of mobility. For example, wireless network 110 may enable a radio connection through a radio network access such as Global System for Mobile communication (GSM), General Packet Radio Services (GPRS), Enhanced Data GSM Environment (EDGE), Wideband Code Division Multiple Access (WCDMA), and the like. In essence, wireless network 110 may include virtually any wireless communication mechanism by which information may travel between mobile devices 102-104 and another computing device, network, and the like.

Network 105 is configured to couple VTC server 106 and its components with other computing devices, including, mobile devices 102-104, client device 101, and through wireless network 110 to mobile devices 102-104. Network 105 is enabled to employ any form of computer readable media for communicating information from one electronic device to another. Also, network 105 can include the Internet in addition to a wide area networks (WANs), direct connections, such as through a universal serial bus (USB) port, other forms of computer-readable media, or any combination thereof. On an interconnected set of networks, including those based on differing architectures and protocols, a router acts as a link between networks, enabling messages to be sent from one to another. Also, communication links within networks typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either network 105 via a modem and temporary telephone link. In essence, network 105 includes any communication method by which information may travel between VTC server 106, client device 101, and other computing devices.

Local area network (LAN) 107 is configured to couple TMS 108 with other computing devices, including VTC server 106. LAN 107 may operate substantially similar to network 105, except LAN 107 may provide additional security and/or controlled access. For example, LAN 107 may exist behind a firewall, proxy server, or the like. Thus LAN 107 may prevent access to, for example, TMS 108, from unauthorized devices, such as client devices 101-104, or the like. In one embodiment, LAN 107 may enable access by VTC server 106 to TMS 108 over a particular, port, or the like.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

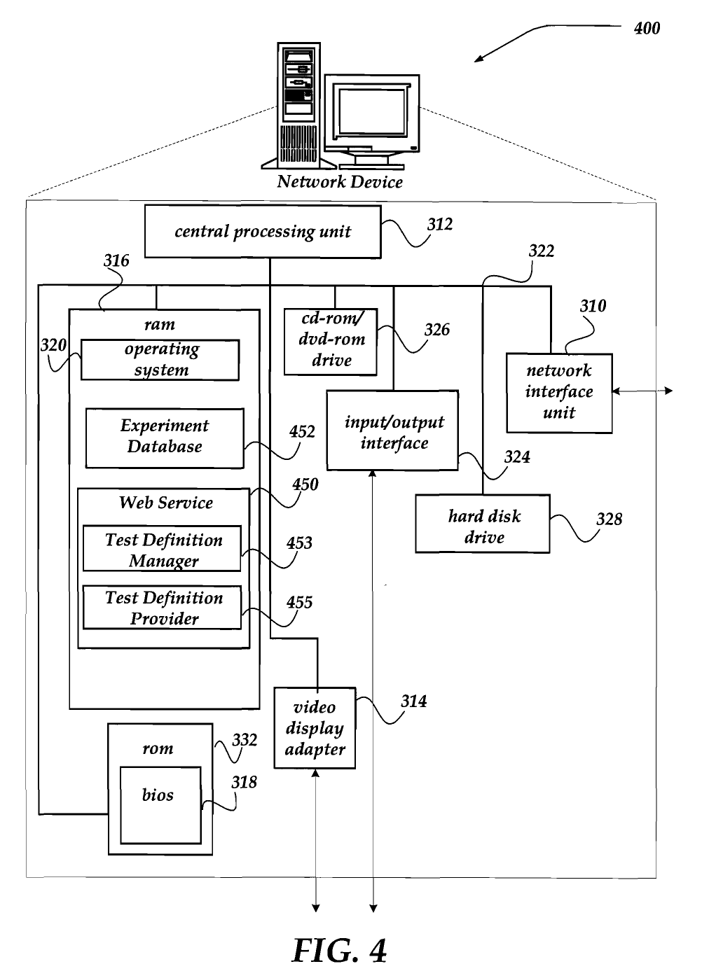

One embodiment of TMS 108 is described in more detail below in conjunction with FIG. 4. Briefly, however, TMS 108 may include any computing device capable of connecting to network 107 to manage and/or provide information about a grouping of visitors, and an association of group of visitors with a particular version of content, or the like.

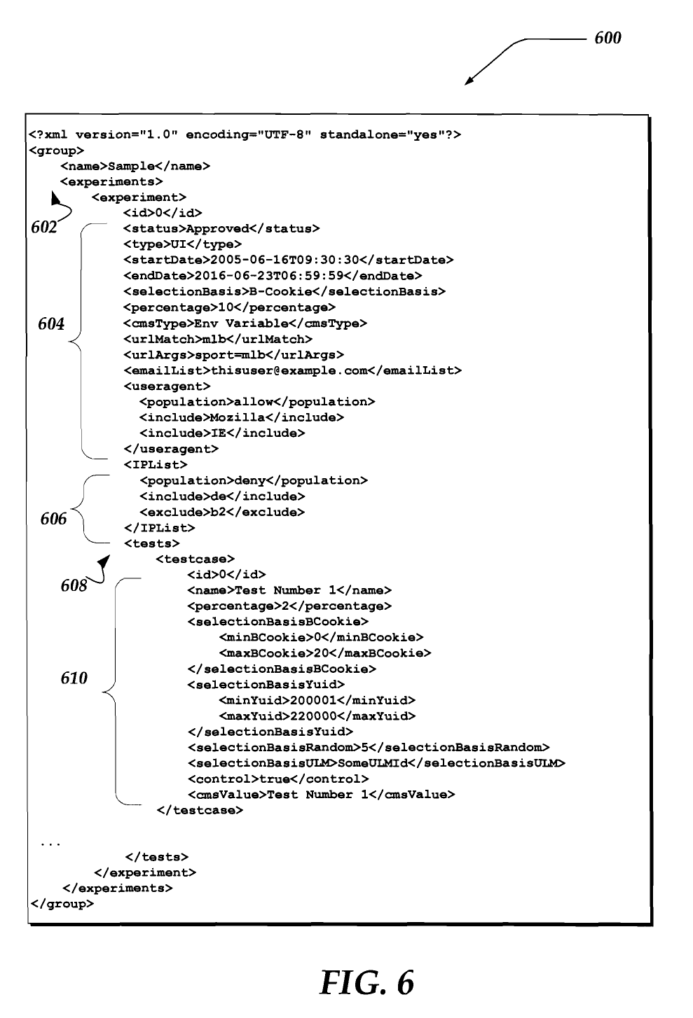

TMS 108 may provide an interface, such as a web interface, or the like, to enable a administrative user (e.g., web manager) to enter a test definition. An example of a test definition file is described in more detail in conjunction with FIG. 6. Briefly, however, in one embodiment, the test definition may be any XML file, text file, spreadsheet, database, or virtually any media for storing information. The test definition may identify, for example, a type of service, device, or the like, that may operate on the test definition. In one embodiment, the test definition may provide that VTC server 106 may operate on the test-definition. The test definition may identify VTC server 106 by an address (e.g., IP address), service type (e.g., mail server, home page server, media server), or the like. In one embodiment, the test definition may associate a percentage of visitors with a particular version of content for an VTC server, such as VTC server 106. For example, a web manager, administrator, or the like, of VTC server 106 may wish to test out different ad locations on a given web page provided by VTC server 106. The web manager may allocate a certain percentage of visitors to view the revised ad locations and another percentage to view the default/current ad locations.

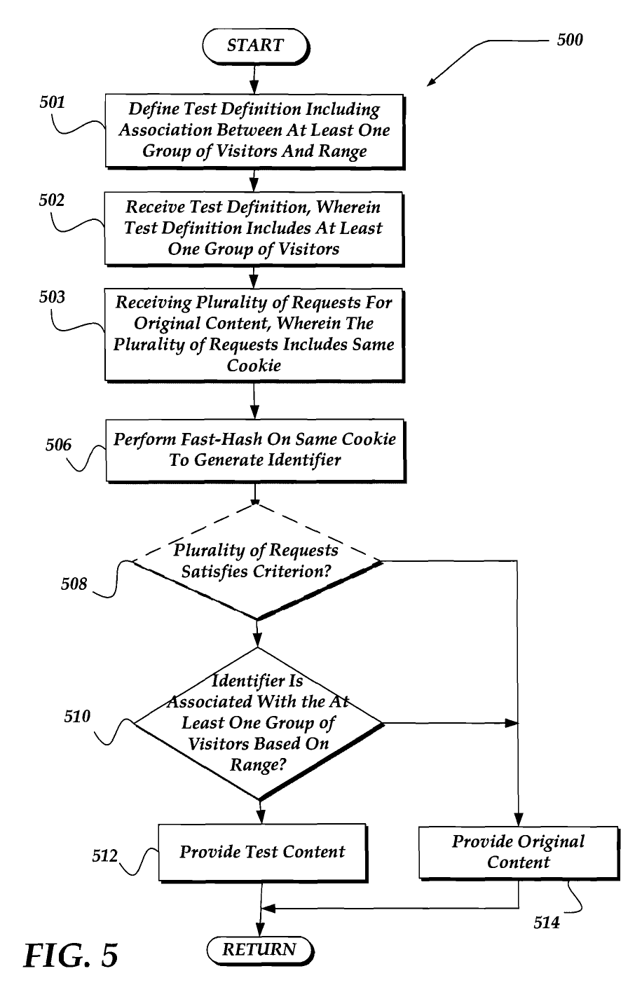

TMS 108 may also manage hierarchical groups of visitors, wherein each group or sub-groups may be associated with at least one type of experimentation or test, or the like. TMS 108 may provide the test definition to VTC server 106 over network 107, or the like. In one embodiment, VTC server 106 may pull the test definition from TMS 108, over for example, FTP, HTTP, XmlHTTPRequest (XHR), or the like. In another embodiment, TMS 108 may push the information to VTC server 106 via FTP, HTTP, XHR, or the like. In one embodiment, the operations of TMS 108 may be performed, for example by process 500 of FIG. 5.

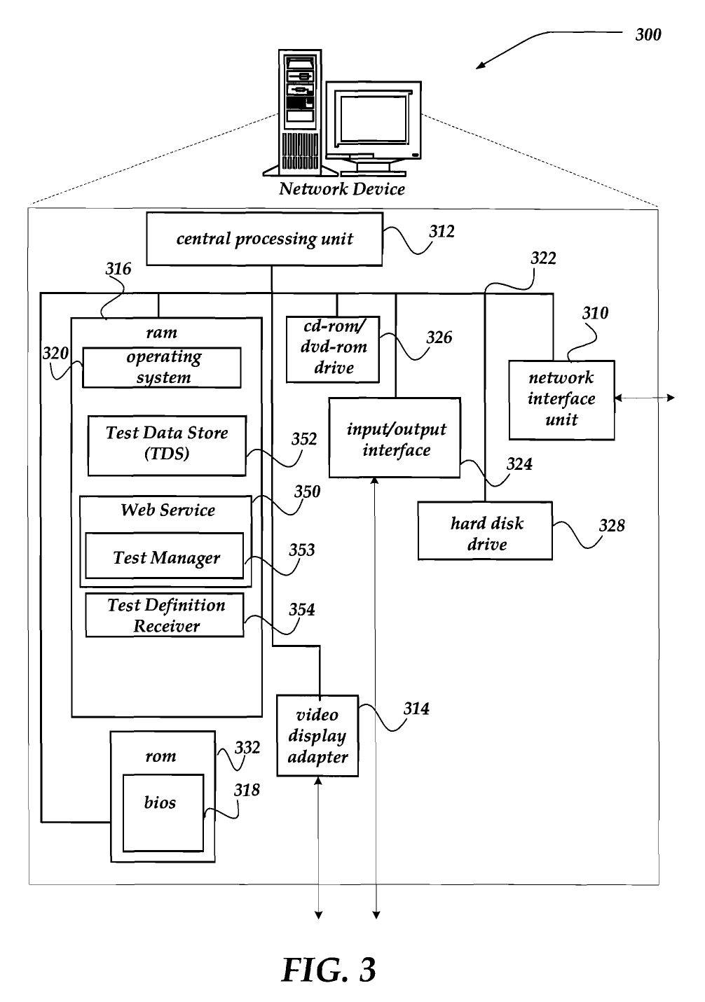

One embodiment of VTC server 106 is described in more detail below in conjunction with FIG. 3. Briefly, however, VTC server 106 may include any computing device capable of connecting to network 105 to determine a version of content to provide a visitor based on characteristics of a request for the content and/or characteristics of a platform, browser, operating system, or device associated with the visitor. In one embodiment, VTC server may receive a request for content (e.g., a web page), may receive a cookie from a client device (e.g., client devices 101-104), may perform a fast-hash based on the cookie, and/or determine which version of the content to provide based on a result of the fast-hash, or the like. VTC server 106 may utilize a cookie (e.g., a B-Cookie) or any other fairly consistent, unique identifier associated with an instance of a browser, or the like. VTC server 106 may also utilize any fast-hash algorithm/very high-speed hashing algorithm, including a Fowler Noll Vo (FNV) hash. In one embodiment, the operations of VTC server 106 may be performed, for example by process 500 of FIG. 5.

Devices that may operate as VTC server 106 and/or TMS 108 include personal computers desktop computers, multiprocessor systems, microprocessor-based or programmable consumer electronics, network PCs, servers, and the like.

Although FIG. 1 illustrates VTC server 106 and TMS 108 as separate components, VTC server 106 and TMS 108 may be combined into one device without departing from the scope of the invention. Moreover, while VTC server 106 and/or TMS 108 may be represented as single computing devices, the invention is not so limited. For example, one or more functions of VTC server 106 may be distributed across one or more distinct computing devices. For example, providing web pages, performing a fast-hash, determining whether a visitor is associated with a visitor group, retrieving a test definition, or the like, may be performed by a plurality of computing devices, without departing from the scope or spirit of the present invention.

### Illustrative Client Environment

FIG. 2 shows one embodiment of client device 200 that may be included in a system implementing one or more embodiments of the invention. Client device 200 may include many more or less components than those shown in FIG. 2. However, the components shown are sufficient to disclose an illustrative embodiment for practicing the present invention. Client device 200 may represent, for example, mobile devices 102-104 of FIG. 1.

As shown in the figure, client device 200 includes a processing unit (CPU) 222 in communication with a mass memory 230 via a bus 224. Client device 200 also includes a power supply 226, one or more network interfaces 250, an audio interface 252, video interface 259, a display 254, a keypad 256, an illuminator 258, an input/output interface 260, a haptic interface 262, and an optional global positioning systems (GPS) receiver 264. Power supply 226 provides power to mobile device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Video interface 259 is arranged to capture video images, such as a still photo, a video segment, an infrared video, or the like. For example, video interface 259 may be coupled to a digital video camera, a web-camera, or the like. Video interface 259 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Haptic interface 262 is arranged to provide tactile feedback to a user of the client device. For example, the haptic interface may be employed to vibrate client device 200 in a particular way when another user of a computing device is calling.

Optional GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of client device 200 on the surface of the Earth. It is understood that under different conditions, GPS transceiver 264 can determine a physical location within millimeters for mobile device 200; and in other cases, the determined physical location may be less precise, such as within a meter or significantly greater distances. In one embodiment, however, mobile device may, through other components, provide other information that can be employed to determine a physical location of the device, including for example, a MAC address, IP address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of mobile device 200. The mass memory also stores an operating system 241 for controlling the operation of mobile device 200. It will be appreciated that this component may include a general-purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Memory 230 further includes one or more data storage 244, which can be utilized by client device 200 to store, among other things, applications 242 and/or other data. For example, data storage 244 may also be employed to store information that describes various capabilities of mobile device 200. The information may then be provided to another device, including being sent as part of a header during a communication, sent upon request, or the like. Moreover, data storage 244 may also be employed to store content including text messages, address books, group member lists, or the like. At least a portion of the content and/or event information may also be stored on storage medium 266, such as a disk drive, removable storage, or the like within mobile device 200.

Applications 242 may include computer executable instructions which, when executed by mobile device 200, provide such functions as calendars, contact managers, task managers, transcoders, database programs, word processing programs, screen savers, security applications, spreadsheet programs, games, search programs, and so forth. Applications 242 may further include Message Managers (MM) 245.

Browser 245 represents any of a variety of applications configured to transmit, receive, and/or otherwise process content. In one embodiment, browser 245 may run under the control of a user (e.g., visitor) of client device 200, or the like. Browser 245 may enable and manage requesting, receiving, and rendering markup pages such as WAP pages (sometimes referred to as WAP cards), SMGL, HTML, HDML, WML, WMLScript, JavaScript, and the like. Browser 245 may receive (HTTP) cookies from a server, may store the cookies in memory, on disk, or the like. In one embodiment, browser 245 may store the cookie unchanged, may send the cookie back to the server upon subsequent access to the server or the like. A visitor may clear a cache of cookies of browser 245, or the like. A visitor may control which cookies, from which websites may be stored on client device 200, or the like. Cookies may be of varying sizes. In one embodiment, the cookies may include a B-Cookie, a 13 character alphanumeric string, or the like. The B-Cookie is generally a browser-based ID component that uniquely identifies a visitor's particular browser whether or not that visitor is logged into an online content service, such as the Yahoo!™ Network.

Illustrative Server Environment FIG. 3 shows one embodiment of a network device, according to one embodiment of the invention. Network device 300 may include many more components than those shown. The components shown, however, are sufficient to disclose an illustrative embodiment for practicing the invention. Network device 300 may represent, for example, VTC server 106 of FIG. 1.

Network device 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. Mass memory may include applications such as transponders, schedulers, calendars, database programs, word processing programs, customizable user interface programs, IPSec applications, encryption programs, security programs, account management, and so forth.

Test Data Store (TDS) 352 stores a plurality of test definitions. In one embodiment, TDS 352 may be a database, a file structure, or the like. TDS 352 may store the test definitions as an XML file, flat file, or the like. In one embodiment, TDS 352 may be an in-memory data store, a cache (e.g., an experiment cache), or the like. In another embodiment, TDS 352 may be a relational database, object oriented database, or the like. In one embodiment, TDS 352 may be an in-memory data store configured for efficient access. For example, TDS 352 may be a flat file database, a memory mapped database, a in memory hash object, or the like. TDS 352 may be configured to manage key/value pairs of arbitrary type and/or length. In any case, TDS 352 may store, manage, update, and/or provide the plurality of test definitions.

Test definition receiver 354 may include any component configured to receive information over network interface 310. In one embodiment, test definition receiver 354, may periodically (e.g., once every 5 minutes), pull data from a test manager server, such as TMS 108 of FIG. 1, over network interface 310. Test definition receiver 354 may use for example, XmlHTTPRequest (XHR), or the like, to retrieve the test definition as an XML file. In one embodiment, the complete test definition file may be retrieved. In another embodiment, only relevant portions of the test definition file that relates to content provided by network device 300 may be received/retrieved. In one embodiment, only changed portions of the test definition (e.g., a delta) may be received. In any case, the test definition may be stored in TDS 352. In one embodiment, at least some operations of test definition receiver 354 may be performed by process 500 of FIG. 5.

Web server 350 is loaded into mass memory and run on operating system 320. Web server 350 may be any type of program configured for providing content over a network interface 310, utilizing, for example an OSI layer 7 protocol. Types of web servers include Apache HTTP Server, Microsoft Internet Information Server, or the like. Web server 350 may be configured to provide content from a directory structure, a virtual directory structure or the like. Web server 350 may provide several application environments, including environments supporting server-side sessions, web programming languages (e.g., Active Server Pages, PHP, Perl, Python) or the like. Web server 350 may also enable a variety of web services, including XmlHTTPRequest (XHR), Asynchronous JavaScript and XML (AJAX), JavaScript Object Notation (JSON) programs, or the like. In one embodiment, an application environment may include persistable objects, variables, or the like, that may last over the lifetime of an execution of web server 350, of the lifetime of a session of interaction with a visitor over network interface 310, or the like.

Web server 350 may also include a mechanism to load modules (e.g., Apache modules, Dynamic Shared Object (DSO) modules, Internet Server Application Programming Interface (ISAPI) filters, dynamically install libraries, or the like), to modify the processing of requests managed by web server 350. For example, web server 350 may be an Apache HTTP server and may support several modules, including mod_perl, mod_ssl, or the like. Each module may modify the requests, limit access, change the application environment, route the requests, or perform virtually any other operation. Results of one module may be passed onto another module for further processing. Each module may be invoked in a particular sequence, priority, ordering, or the like. For example, a basic module for verifying a URL may be invoked before a module for redirecting the request to another URL.

Test manager 353 may operate within web server 350. In other words, test manager 353 may be an application, program, module, or the like, that may be invoked as part of the processing of requests by web server 350. In one embodiment, test manager 353 may be invoked at a high priority. For example, test manager 353 may be invoked to manage a request before any other, or substantially any other modules are invoked.

Test manager 353 may be in communication with web server 350. Test manager 353 may receive from web server 350, a cookie or other Previously Generated Value (PGV) associated with a request. Test manager 353 may perform a fast-hash on the cookie. In one embodiment, test manager 353 may be in communication with TDS 352. Test manager 353 may access within TDS 352, group information, such as a range of numbers associated with a group of visitors. Test manager 353 may, based on whether the result of the fast-hash is in the range, direct web server 350 to provide a particular response, content, or the like.

As an example, before web server 350 provides a visitor a requested webpage that is under experiment/test, the visitor's unique B-Cookie is hashed into a value between 0 and 999. A range of the values may define a group of visitors. For example, if the user of client device 300 (e.g., a website's manager) chooses to target 5% of the website's visitors for a given experiment/test on a webpage (or set of webpages), then test manager 353 may identify, as being in that specific group, the visitors whose B-Cookies hash to 0 through 49. And, when each of the visitors returns to the page, the visitors will be identified in a substantially similar way. Similarly, if a visitor is determined to not be a part of the group, the visitor will not be selected upon future visits.

Moreover, based on the identification/determination that a visitor belongs in a group, test manager 353 may reply to the request with a different content than the content intended for a visitor who does not belong to the group. For example, test manager 353 may redirect the request to another URL, may redirect the request to a different document root (e.g., a different Apache DocRoot virtual folder), or the like.

Alternately, test manager 353 may set at least one server-side variable in an application environment of web server 350 and/or client-side variable (e.g., another cookie), or the like. For example, test manager 353 may assign a specific variation to a factor in an environmental variable. The factor may be a variable name, and the variation may be the value of the variable.

In another embodiment, test manager 353 may enable a particular HTTP operation to be performed (e.g., processing of a GET request, PUT request, upload, or the like). In one embodiment, test manager 353 may invoke a particular algorithm. For example, if a result of the fast-hash indicates that a visitor belongs in a test group, then a different search algorithm may be used to provide a search result for the visitor, based on the visitor's search query. In one embodiment, at least some operations of test manager 353 may be performed by process 500 of FIG. 5.

FIG. 4 shows one embodiment of a network device, according to one embodiment of the invention. Network device 400 may include substantially similar components as network device 300 of FIG. 3. However, network device 400 may include different components specific to, for example, a test management server, such as TMS 108 of FIG. 1.

As shown, network device 400 may include experiment database 452, web service 450, test definition manger 453, and test definition provider 455.

Experiment database 452 includes any component configured to store a plurality of test definitions. Experiment database 452 may be substantially similar to TDS 352 of FIG. 3. Experiment database 452 may be a database, a file structure, or the like. Experiment database 452 may store the test definitions as an XML file, flat file, or the like. In another embodiment, experiment database 452 may be a relational database, object oriented database, or the like. In any case, experiment database 452 may store, manage, update, and/or provide the plurality of test definitions.

Web service 450 may be any type of program configured for providing content over a network interface 310, utilizing, for example an OSI layer 7 protocol. In one embodiment, web service 450 may operate substantially similar to web service 350. Additionally, web service 450 may provide additional security, authentication, authorization or the like. For example, web service 450 may provide web access over HTTPS.

Test definition provider 455 may include any component configured to provide information over network interface 310. Test definition provider 455 may be a module, application, program or the like within web service 450. In one embodiment, test definition provider 455 may provider test definitions over XHR. In one embodiment, test definition provider 455 provides a test definition based on a request by, for example, test definition receiver 354 of FIG. 3, VTC server 106 of FIG. 1, or the like. In another embodiment, test definition provider 455 may manage a list of possible VTC servers, and may push the test definition to the VTC server. In any case, test definition provider 455 may access the test definition from experiment database 452. In one embodiment, at least some operations of test definition provider 455 may be performed by process 500 of FIG. 5.

Test definition manager 453 may include any component configured to manage an interface for entering a test definition, via, for example, a proprietary interface, a web interface, or the like. While shown as running within web service 450, test definition manager 453 may be a stand alone application, or the like. In one embodiment, test definition manager 453 may be a web page, an secured/internal web portal, or the like. Test definition manager 453 may store the test definition(s) in, for example experiment database 452. In one embodiment, at least some operations of test definition manager 453 may be performed by process 500 of FIG. 5.

### Generalized Operation

The operation of certain aspects of the invention will now be described with respect to FIG. 5. FIG. 5 illustrates a logical flow diagram generally showing one embodiment of a process for providing content over a network. Process 500 may also be performed by VTC server 106 and/or Test manager server (TCS) 107 of FIG. 1.

Process 500 begins, after a start block, at block 501, where a test definition is defined. A user of TCS 107 of FIG. 1 may for example enter the test definition. The test definition may be associated with a server such as VTC server 106, a website, web page, or the like. The test definition may include an association between at least one group of visitors (e.g., of VTC server 106) and a range. While the specific visitor may not yet be determined, the range defines the grouping that will include the visitors to be tested. Associations between ranges and groups of visitors may be stored in a datastore, database, provided over a network, or the like. The range may be any set of values. The range may be an ordered set of values (e.g., numbers, strings, etc). In one embodiment, the range may be 0-999, where each number may represent 1/10^{th} of a percent of all possible visitors. For example, if an experiment/test is to be targeted to 5% of a website's visitors, a corresponding group of visitors may be associated with the range 0-49.

In one embodiment, there maybe a plurality of groups of visitors, with each group of visitors associated with a different range. In another embodiment, the plurality of groups of visitors may be a hierarchy of groups. In this embodiment, each group of the hierarchical groups of visitors is associated with a range representing a percentage of total visitors, and wherein a child range for a child group in the hierarchical groups is included in a parent range for a parent group of the child group. For example, group A may be associated with the range 0-99. Group B and C may be all the children of group A. Group B may be associated with the range 0-49, and group C may be associated with 50-99. Thus, in one embodiment, group A may represent an experiment/test to be performed on 10% of a website's visitors. Group B may represent a sub-test to be performed on 50% of the 10% (e.g., 5% of the website's visitors), and correspondingly group C may represent the other 50% of the 10%. In any case, processing next continues to block 502.

At block 502, a test definition is received. The test definition may include at least one group of visitors. In another embodiment, the test definition may only be the group of visitors. In another embodiment, the test definition may include other information. For example, the test definition may include a range (e.g., a range of numbers, a range of values, a range of characters) associated with the at least one group of visitors. The test definition may also include a criterion to be determined to be satisfied before a particular content may be provided. The criterion may be a URL filter, a browser type, operating system type, a time-range, an argument-value pair, or virtually any other filter. In one embodiment, the test definition may be an XML file. The XML file may include a criterion associated with one tag of the XML file, and the group of visitors with another tag. In one embodiment, where the test definition includes a hierarchical group of visitors, a parent tag of the XML file may be associated with a parent group, and a child tag may be associated with a child group.

In one embodiment, the test definition may be retrieved periodically (e.g., based on a schedule, a timer, or the like). In one embodiment, the test definition may be stored in a local storage, an in-memory storage, or the like. In an alternate embodiment, the test definition may be read over a network from a central database, datastore or the like, using a database operation (e.g., SQL statement), XML service, web service, or the like. In one embodiment, a local storage of the test definition might not be used. In one embodiment, the test definition may be received using a pull operation (e.g., using XHR, JSON, XML). For example, VTC server 106 may retrieve the test definition from TCS 107 of FIG. 1. In another embodiment, the test definition may be received using a push operation. For example, TCS 107 may send the information to VTC server 106. In any case, processing continues to block 504.

At block 504, a plurality of requests for a first content is received. In one embodiment, the first content may be an original content intended to be retrieved by a visitor. For example, the visitor may request their original homepage. The visitor may not know that a test/experiment may be performed on their access to the homepage. In one embodiment, at least some of the plurality of requests may be received at a different time. In one embodiment, the plurality of requests is received from the same visitor, the same browser, the same client device, or the like. The plurality of requests may include a previously generated value (PGV) that may or may not be unique. In one embodiment, the plurality of requests from the same visitor, browser, client device, or the like, may include the same PGV. In one embodiment, The PGV may be an HTTP cookie, or any other form of network header information useable for identifying a visitor, client device, an instance of a browser, a type of a browser, or the like. In one embodiment, the cookie and/or PGV may be generated for a particular instance of a browser executable on a client device. In an alternate embodiment, a plurality of PGVs/cookies may be received. Processing then continues to block 506.

At block 506, a fast-hash may be performed on the cookie and/or PGV to generate an identifier. In one embodiment, the fast-hash may be a Fowler Noll Vo (FNV) hash. In another embodiment, the fast-hash may be any other many-to-one deterministic mapping function. In another embodiment, any hashing function may be used. In any case, for the same cookie and/or PGV, the fast-hash generates the same identifier. The identifier may be a number, an alphanumeric string, or the like. In one embodiment, the identifier may be within a range (e.g., the identifier may be a value in a space of ordered values). In one embodiment, the FNV hash may be configured to map a 13 character alphanumeric string into a space of numbers between 0-999. In one embodiment, the fast-hash may be performed on each cookie of the same cookie included with each of the plurality of requests. Accordingly, in this embodiment, the fast-hash may provide the same identifier for each of the plurality of requests. Moreover, in another embodiment, the test definition may include a plurality of groups of visitors, and each identifier generated by the fast-hash may be associated with at most one of the plurality of groups of visitors. Thus, in this embodiment, the fast-hash will reproducibly provide the same mapping to the same group of visitors. In an alternate embodiment, the fast-hash may be performed on a plurality of received cookies. Processing then continues to decision block 508.

In one embodiment, decision block 508 may be optional, and processing may continue directly to block 510. In other embodiments, at decision block 508, it is determined whether the plurality of requests satisfies a test criterion. In one embodiment, this determination maybe based on whether the plurality of requests (e.g., each of the plurality of the requests) 1) matches a URL filter, 2) is associated with a location, operating system, or browser type, 3) occurs at a time within a time range, 5) is associated with an argument-value pair included in the plurality of requests, or 5) based on any other criterion of a characteristic of each, some or all of the plurality of requests and/or a characteristic of the visitor. In any case, if the plurality of requests satisfies at least the other criterion, then processing continues to block 510. Otherwise, processing continues to block 514.

At decision block 510, it is determined whether the identifier is associated with the at least one group of visitors. In one embodiment, it is determined whether the identifier is within the range associated with the group of visitors. For example, the fast-hash function may map a PGV/cookie in the form of a 13 character alphanumeric string onto the number/identifier 9. The range 0-100 may be associated with the at least one group of visitors. It is determined that the number 9 is within the range 0-100, and thus the identifier is associated with the group of visitors. If it is determined that the PGV/cookie/identifier is associated with the at least one group of visitors, then processing continues to decision block 512. Otherwise, processing continues to block 514.

At block 512, a second content may be provided. In one embodiment, the second content may be a test content. For example, a visitor requesting their original homepage may receive instead a different version, configuration, or the like, of their homepage. In one embodiment, the second content may be the same or substantially the same as the first content, but a different algorithm, process, method or the like may be used to process the request, generate the second content, or the like. In another embodiment, the second content may be provided by another HTTP operation. The other HTTP operation may include: 1) providing the second content that is different than the first content, 2) performing an algorithm that is different than another algorithm requested to be performed by the HTTP operation, 3) providing (e.g., setting or defining) a server-side variable, 5) providing a client-side variable, wherein the client-side variable includes the number, or any other operation. In one embodiment, a server-side script (e.g., an ASP page), may read the server-side variable, and based on a value of the server-side variable may provide new or experimental content. In another embodiment, a web page may include code, such as JavaScript code enabled to read the client-side variable, and to act appropriately if the client-side variable is set. For example, the web page may provide new or experimental content based on the value of the client-side variable. Processing then returns to a calling process for further processing.

At block 514, the first content is provided. In one embodiment, the original content may be provided because the visitor is determined not be tested. For example, a visitor requesting their original homepage may receive that homepage. In one embodiment, the first content may be provided virtually by any mechanism, including performing an HTTP operation, providing a web page from a directory, dynamically generating web content based on a script, database information, or the like. In any case, processing then returns to a calling process for further processing.

It should be noted that blocks 504, 506, 508, 510, 512, and 514 may be performed for only one request without departing from the scope of the invention. Moreover, blocks 504, 506, 508, 510, 512, and 514 may be performed for a plurality of requests in sequence, at the same time, or in any combination, without departing from the scope of the invention.

It should also be noted that blocks of process 500 may be performed in a different order than the one shown without departing from the scope of the invention. For example, decision block 510 may be performed before decision block 508.

One skilled in the art will appreciate that process 500 may ensure that proper percentages of visitors are placed into an experiment/test group and that these same visitors of a website are treated the same or similar way upon any future return the website under experiment/test. Moreover, process 500 may ensure that the process for treating same visitor in the same or similar way is done in a reproducible, fast, and efficient manner.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

### Example Test Definition File

FIG. 6 shows an example XML test definition file according to one embodiment of the invention. As shown, test definition file (TDF) 600 includes a plurality of embedded tags for defining a plurality of experiments. Experiments tag 602 defines, for example the experiments to be performed by a visitor targeting/content (VTC) server. Experiments tag 602 may include a plurality of experiment sections delineated by the tag “experiment.” Tags in section 604, for example, defines some of the features of an experiment. For example, the experiment may be identified by an “id” tag, may be defined to start and end within a duration of time defined by a “startDate” and “endDate” tag. Section 604 also shows a “selectionBasis” tag which defines what types of cookies to use to perform by for example, process 500 of FIG. 5. Section 604 may also define what percentage of the complete population may be considered for testing based on the “percentage” tag. For example, if only 10% will be considered, then the “percentage” tag's value would be 10. Section 604 may also define a URL filter to with the “urlMatch” tag. If a request from a visitor is a match (e.g., string match, partial string match, fuzzy match, etc) of the value of the “urlMatch” tag, then the visitor belongs in the experiment and may be considered for testing. The “useragent” tag may also filter particular types of browsers/operating systems for which testing may be considered.

Moreover, each experiment may also have an “IPList” section which defines which requests from which locations may be considered for testing or not considered for testing. For example, requests from German websites may be considered for testing of German content, but no other requests may be considered. While section 604 and 606 shows several filter criteria, any other criteria may be used without departing from the scope of the invention.

It should be noted that matching the criteria of section 604 and 606 determines whether a request may be considered for testing. However, in one embodiment, actual testing (e.g., provisioning of test content) to the visitor is performed if the visitor matches the criteria defined by a specific “testcase” tag. As shown, the section 610 shows several tags for defining a particular test case. A “percentage” tag may define what percent of those visitors who satisfies the criteria for the experiment should be tested. As shown, “percentage” tag defines that 2% of the 10% of the population should be tested. Other criteria may also be used to limit the type of visitors to be tested. For example, visitors associated with particular ranges of B-cookies may be tested, or visitors associated with particular ranges of user specific cookies may be tested. The tags “selectionBasisBcookie” and “selectionBasisYuid” may define these two ranges, respectively.

Moreover, section 610 also defines how test content may be provided. For example, variables may be set if the user is determined to be in a test group (e.g., a test case). A server-side or client-side variable may be set to be the “cmsValue.” For example, the cmsValue may be set to “Test Number 1.” As shown, one test case is shown, and one experiment is shown in TDF 600, however any number of test cases and experiments may be included without departing from the scope of the invention.

### Alternate Logical Architecture

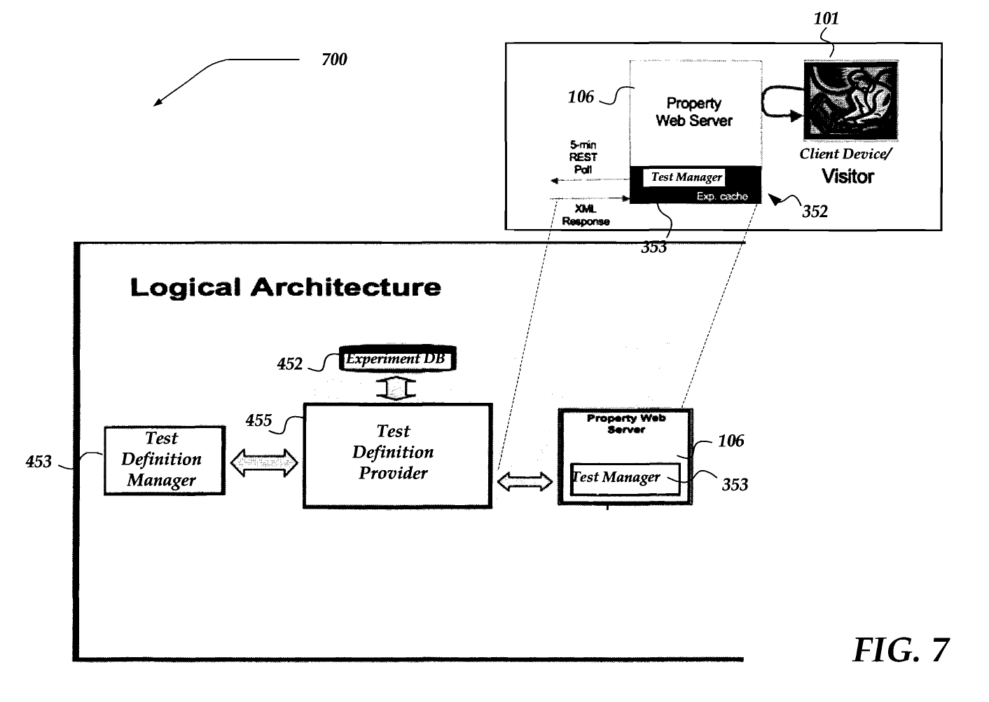

FIG. 7 shows an alternate logical architecture according to one embodiment of the invention. As shown, logical architecture 700 includes at least some components of system 100, network device 300, and/or network device 400. For example, test definition manager 553, test definition provider 455, experiment database 452, data property web server 106, test manager 353, experiment cache/test data store 352 and client device 101 used by a visitor are described above. Logical architecture 700 may include many more components than those shown. The components shown, however, are sufficient to disclose an illustrative embodiment for practicing the invention.

As shown, logical architecture 700 includes test definition manager 453, test definition provider 455, experiment database 452, property web server 106 (e.g., visitor targeting/content (VTC) server), test manager 353, experiment cache/test data store 352 and client device 101 used by a visitor. Test definition provider 455 is in communication with test definition manager 453, experiment database 452, and property web server 106. Property web server 106 is in further communication with client device 101. Components of logical architecture 700 may communicate with each other over, for example, a network, or any for of communication mechanism.

As shown, test manager 353, in one embodiment, may communicate with test definition provider by retrieving or polling test definition provider 455 every 5 minutes. Any time period may also be used without departing from the scope of the invention. Test definition provider 455 may provide a test definition to test manager 353 as, for example, and XML response.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A method for providing content over a network, comprising:
receiving a test definition, wherein the test definition comprises at least one range associated with at least one group of visitors;
receiving a first request for an HTTP operation and a cookie from a visitor;
performing a Fowler Noll Vo (FNV) hash on the cookie to generate a number; and
enabling another HTTP operation to be performed based on whether the number generated by the FNV hash is in the at least one range.

2. The method of claim 1, further comprising:
receiving a second request for the HTTP operation and the cookie from the visitor;
performing another FNV hash on the cookie to generate the number; and
enabling the other HTTP operation to be performed based on whether the number generated by the other FNV hash is in the at least one range.

3. The method of claim 1, wherein enabling the other HTTP operation to be performed is further based on at least one of:
whether the request matches a URL filter,
the request is associated with a location, operating system, or browser type,
the request occurs at a time within a time range, or
the request is associated with an argument-value pair.

4. The method of claim 1, wherein the cookie identifies at least one of an instance of a browser, a user, an operating system, or a location.

5. The method of claim 1, wherein enabling the other HTTP operation to be performed further comprises at least one of:
providing content that is different than another content requested to be provided by the HTTP operation,
performing an algorithm that is different than another algorithm requested to be performed by the HTTP operation,
providing a server-side variable, or
providing a client-side variable, wherein the client-side variable includes the number.

6. The method of claim 1, wherein receiving the test definition comprises:
retrieving periodically the test definition.

7. The method of claim 1, wherein the test definition comprises hierarchical groups of visitors, and further comprising:
associating each group of the hierarchical groups of visitors with a range of numbers representing a percentage of total visitors, and wherein a child range for a child group in the hierarchical groups is included in a parent range for a parent group of the child group.

8. A system for providing content over a network, comprising:
a test manager server operable to perform actions comprising:
receiving the test definition; and
providing the test definition to a Visitor Targeting/Content (VTC) server if the VTC server is authorized to receive the test definition, wherein the test definition comprises at least one group of visitors;
the VTC server operable to perform actions comprising:
receiving a first request for an HTTP operation and a cookie from a client device;
performing a fast-hash on the cookie to generate a number; and
enabling another HTTP operation to be performed based on whether the number generated by the fast-hash is associated with at least one group of visitors; and
providing a result to the client device based on the other HTTP operation;
a client device operable to perform actions comprising:
sending the first request for the HTTP operation and the cookie, wherein the cookie is associated with the client device; and
receiving, in response to the first request, the result.

9. The system of claim 8, wherein the VTC server is further operable to perform actions comprising:
receiving a second request for the HTTP operation and the cookie from the visitor;
performing another fast-hash on the cookie to generate the number; and
enabling the other HTTP operation to be performed based on whether the number generated by the other fast-hash is associated with the at least one group of visitors.

10. The system of claim 8, wherein the cookie identifies an instance of a browser.

11. The system of claim 8, wherein the VTC server is further operable to perform actions comprising:
retrieving the test definition based on a schedule.

12. The system of claim 8, wherein client device is a mobile device.

13. The system of claim 8, wherein the fast-hash includes a Fowler Noll Vo (FNV) hash.

14. The system of claim 8, wherein the test definition includes a plurality of groups of visitors, and wherein each number generated by the fast-hash is associated with at most one of the plurality of groups of visitors.

15. A network device for providing content over a network, comprising:
a transceiver to send and receive data over the network; and
a processor operable to perform actions comprising:
receiving a test definition, wherein the test definition comprises at least one test group;
receiving a first request for an HTTP operation and a cookie from a visitor;
performing a fast-hash on the cookie to generate an identifier within a range of identifiers; and
enabling another HTTP operation to be performed based on whether the identifier generated by the fast-hash is in the at least one group of visitors.

16. The network device of claim 17, where the actions further comprises:
receiving a second request for the HTTP operation and the cookie from the visitor;
performing another fast-hash on the cookie to generate the identifier; and
enabling the other HTTP operation to be performed based on whether the identifier generated by the other fast-hash is in the at least one group of visitors.

17. The network device of claim 17, further comprising:
an in-memory database configured to associate at least one identifier to a group of visitors, and
wherein the actions further comprises:
refreshing the in-memory database with another test definition, wherein refreshing comprises modifying the at least one group of visitors.

18. The network device of claim 17, further comprising:
a server-side application environment configured to manage a session for a visitor and wherein enabling the other HTTP operation to be performed further comprises changing a value of a session variable in the sever side application environment associated with the at least one group.

19. A processor readable medium having processor executable instructions for providing content over a network, the processor executable instructions configured to enable a processor to perform actions, comprising:
receiving a plurality of requests for content from a browser, wherein each of the plurality of requests includes a same previously generated value (PGV) identifying the browser;
performing, for each of the plurality of requests, a hash on the same PGV to generate a number; and
providing another content based on whether the number generated by the hash is associated with a targeted group of visitors.

20. The processor readable medium of claim 19, where the actions further comprises:
receiving hierarchical groups of visitors, wherein each of the groups of the visitors represents a percentage of visitors, and wherein the targeted group of visitor is one of the hierarchical groups of visitors.
